(19) United States
(12) Patent Application Publication
(10) Pub. No.: US 2008/0227062 A1
(43) Pub. Date: Sep. 18, 2008

(54) Phonetic teaching/correcting device for learning Mandarin

(76) Inventor: Chen-Ming Yang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,721

(22) Filed: Mar. 14, 2007

(51) Int. Cl. G09B 19/06

(52) U.S. Cl. 434/157

(57) ABSTRACT

A phonetic teaching/correcting device for learning Mandarin includes a book having a plurality of pages. At least one page includes a Chinese character. Also provided on the same page is at least one phonetic symbol component that constitutes a phonetic symbol combination representing pronunciation of the Chinese character. Also provided on the same page are a first mark in association with pronunciation of the Chinese character and a second mark in association with pronunciation of each phonetic symbol component. A speaker outputs pronunciation of one of the Chinese character and the phonetic symbol component scanned by a reader.

### BACKGROUND OF THE INVENTION

1. Field of the Invention

The present invention relates to a phonetic teaching/correcting device for learning language and, more particularly, to a phonetic teaching/correcting device for learning Mandarin.

2. Description of the Related Art

Language is a key to culture contact, merging into a society, etc. The rise of the Mainland China in economics has brought a global tide in learning Chinese or Mandarin. It is estimated around 30 million people are learning Mandarin around the world now, and the potential learners are more.

There are two types of Mandarin characters: Simplified Chinese characters mainly used in Mainland China and having a phonetic system named “Hanyu Pinyin” or simply “Pinyin”; and Traditional Chinese characters mainly used in Taiwan and having a phonetic system named “Zhuyin fuhao” (often abbreviated as “Zhuyin”, or known as “Bopomofo”). Despite of differences in learning, the two language systems of Mandarin have many things in common. For example, Simplified characters and Traditional characters are substantially the same in pronunciation and meaning in addition to similarity between different shapes.

Mandarin can be learned in regular schools or clam schools. Pronunciation is the primary threshold of any methods for learning Mandarin. The learners will severely mispronounce words and hence require correction if they receive wrong teachings from their teachers or through non-standard learning systems. Even if the teachers teach correct pronunciation, the teachers are not available at any time while repeated pronunciation is not pleasant to the teachers during the class. In view of high cost and inconvenience encountered during learning Mandarin, there is a need in a teaching/correcting device to allow repeated teaching or correction of pronunciation of Mandarin in an economic and efficient way in this modern world full of advanced technology, for repeated practice is the key to learning language.

### SUMMARY OF THE INVENTION

The present invention provides a phonetic teaching/correcting device for learning Mandarin having a plurality of Chinese characters and a phonetic system that includes a plurality of phonetic symbols and a plurality of tone marks representing a plurality of tones. Pronunciation of each Chinese character is represented by a phonetic symbol combination including one of the tone marks and at least one phonetic symbol component each of which is one of the plurality of phonetic symbols.

The phonetic teaching/correcting device according to the preferred teachings of the present invention includes a book having a plurality of pages. At least one of the plurality of pages includes a first Chinese character. Also provided on the same page is at least one phonetic symbol component that constitutes a first phonetic symbol combination representing pronunciation of the first Chinese character. Also provided on the same page are a first mark in association with pronunciation of the first Chinese character and a second mark in association with pronunciation of each phonetic symbol component. A reading device is used together with the book and includes a reader for identifying the first and second marks, a processing unit, and a memory storing pronunciation information of a plurality of Chinese characters including the first Chinese character. The reader is a barcode reader, a magnetic strip reader, a radio frequency identification reader, or an optical character recognition reader. The processing unit receives and processes identification result of the reader and outputs information of pronunciation of one of the first Chinese character and the phonetic symbol component scanned by the reader The reader further includes a wireless transmitter for transmitting signal indicative of the pronunciation of one of the first Chinese character and the phonetic symbol component scanned by the reader to a wireless receiver on a speaker that outputs the pronunciation of one of the first Chinese character and the phonetic symbol component scanned by the reader.

In a preferred form, the first phonetic symbol combination representing pronunciation of the first Chinese character is provided on the same page and located beside the first Chinese character.

The first mark may be a barcode within or beside the first Chinese character, the second mark may be a barcode within or beside each phonetic symbol component of the first Chinese character, and the reader may be a barcode reader. In an alternative example, the first mark is the shape of the first Chinese character, the second mark is the shape of each phonetic symbol component of the first Chinese character, and the reader is an optical character recognition reader.

In the preferred form, another four Chinese characters having four phonetic symbol combinations respectively representing pronunciation of the four Chinese characters are provided on the same page. Each of the four phonetic symbol combinations representing pronunciation of the four Chinese characters includes at least one phonetic symbol component identical to that of the first Chinese character. The phonetic symbol combinations representing pronunciation of the first Chinese character and the four Chinese characters have different tone marks. A mark in association with the pronunciation of each of the four Chinese characters is also provided on the same page, and the speaker outputs the pronunciation of one of the four Chinese characters when the mark is scanned by the reader.

In the preferred form, a plurality of derivative Chinese words derived from the first Chinese character and the four Chinese characters are provided on the same page. A plurality of drawings corresponding to the derivative Chinese words derived from the first Chinese character and the four Chinese characters are also provided on the same page.

The phonetic system is Zhuyin fuhao system or Hanyu Pinyin system.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a reading device of a phonetic teaching/correcting device in accordance with the present invention.

FIG. 2 is a perspective view of an embodiment of a book of the phonetic teaching/correcting device in accordance with the present invention.

FIG. 3 is an enlarged view of a phonetic symbol on a page of the book of FIG. 2.

FIG. 4 is a plan view of another embodiment of the book of the phonetic teaching/correcting device in accordance with the present invention.

FIG. 5 is an enlarged view of a phonetic symbol on a page of the book of FIG. 4.

### DETAILED DESCRIPTION OF THE PREFERRED EMBODIMENTS

A phonetic teaching/correcting device in accordance with the present invention includes a reading device 1 and a book. The book may be of any form including but not limited to the books 2, 2A respectively shown in FIGS. 2 and 3, which will be described hereinafter.

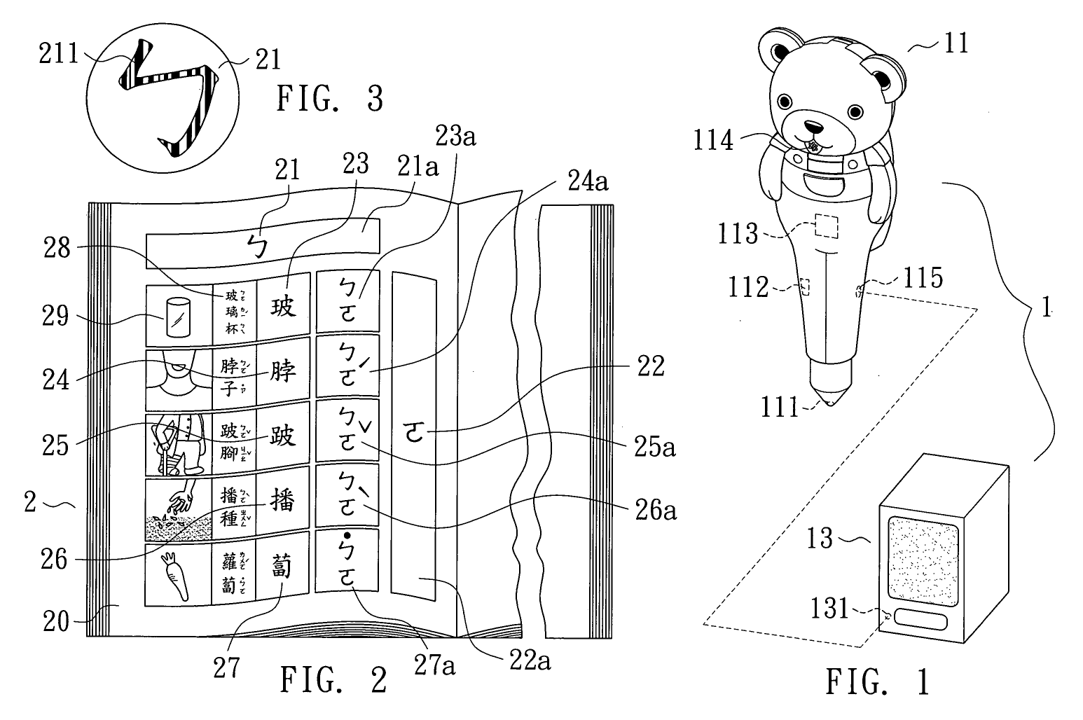

With reference to FIG. 1, the reading device 1 of the phonetic teaching/correcting device in accordance with the present invention includes a reader 11 such as a barcode reader, magnetic strip reader, radio frequency identification (RFID) reader, or optical character recognition reader. Specifically, the reader 11 includes a reading element 111 and a processing unit 112 that is connected to a memory 113. The memory 113 may be a built-in memory or an external memory card in which correct pronunciation of Chinese characters in the book 2, 2A are stored. The reader 11 further includes a microphone 114 connected to the processing unit 112 for converting processed information into audio signal such that the pronunciation of a specific character on the book scanned by the reader 11 can be output after processing by the processing unit 12. The reader 11 may further include a wireless transmitter 115 for cooperating with a wireless receiver 131 mounted on a speaker 13 such that the processed information can be converted into audio signal and output by the speaker 13; namely, the pronunciation of a specific character on the book 2, 2A scanned by the reader 11 can be output through the speaker 13.

An embodiment of the book is shown in FIG. 2 and designated “2”. The book 2 includes a plurality of pages 20. At least one of the pages 20 includes a Chinese character 23 (see the Traditional Chinese character [symbol] Also shown on the same page is its corresponding phonetic symbol combination of one of Mandarin phonetic systems. In the embodiment shown in FIG. 2, Zhuyin fuhao system is used. Specifically, the Zhuyin fuhao system includes 37 special symbols to represent Mandarin sounds. The 37 special symbols can be divided into a first group of phonetic symbols and a second group of phonetic symbols. More specifically, the first group of phonetic symbols of Zhuyin fuhao includes [symbol] [symbol] [symbol] [symbol] and [symbol] whereas the second group of phonetic symbols of Zhuyin fuhao includes [symbol] [symbol] [symbol] and [symbol] Pronunciation of each Chinese character can be represented by a phonetic symbol combination including at least one of the 37 phonetic symbols and one of five tones of the Zhuyin fuhao phonetic system.

The Zhuyin fuhao (or phonetic symbol combination, see reference number 23a) of the Chinese character 23 is preferably beside the Chinese character. In the embodiment shown in FIG. 2, the Chinese character 23 includes two phonetic symbol components [symbol] (see the phonetic symbol designated by reference number 21) and [symbol] (see the phonetic symbol designated by reference number 22) which are respectively shown in a first phonetic symbol display section 21a above the Chinese character 23 and a second phonetic symbol display section 22a at a right side of the phonetic symbol combination 23a to show the constitution of the Zhuyin fuhao symbols of the Chinese character 23.

Furthermore, other Chinese characters 24, 25, 26, and 27 (see the Traditional Chinese characters [symbol] and [symbol] below the Chinese character 23) are provided on the same page. These Chinese characters 24-27 have the same Zhuyin fuhao symbol components as those of the Chinese character 23 but have different tones (see reference numbers 24a, 25a, 26a, and 27a).

A mark 211 is provided within or beside each of the phonetic symbol component 21, the phonetic symbol component 22, and the Chinese characters 23-27. The mark 211 contains pronunciation information in association with the corresponding one of the phonetic symbol component 21, the phonetic symbol component 22, and the Chinese characters 23-27. As an example, a barcode 211 is contained in the phonetic symbol component 21 (see FIG. 3).

In a case that the reader 11 is a barcode reader, magnetic strip reader, or RFID reader, the mark 211 can be a barcode. In another case that the reader 11 is an optical character recognition reader, the mark 211 is the shape of the corresponding one of the phonetic symbol component 21, the phonetic symbol component 22, and the Chinese characters 23-27. After reading the mark 211 with the optical character recognition reader, the shape of the mark 211 is identified by built-in software in the optical character recognition reader and converted into audio signal and then output via the microphone 114 or the speaker 13.

Furthermore, derivative Chinese words 28 derived from the Chinese characters 23-27 and corresponding drawings 30 can be provided on the same page (see the first and second columns below the phonetic symbol component 21).

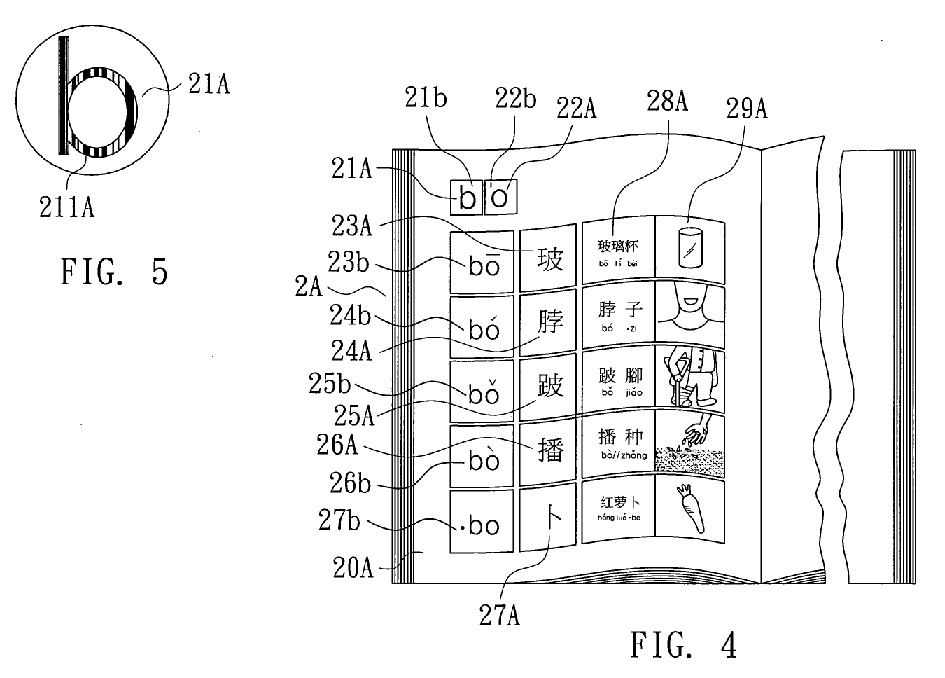

Another embodiment of the book is shown in FIG. 4 and designated “2A”. The book 2A includes a plurality of pages 20A. At least one of the pages 20A includes a Chinese character 23A (see the Simplified Chinese character [symbol] Also shown on the same page is its corresponding phonetic symbol combination of another Mandarin phonetic system. In the embodiment shown in FIG. 4, Hanyu Pinyin system is used. Specifically, the Hanyu Pinyin system includes a plurality of consonant letters (or first group of phonetic symbols) and a plurality of vowel letters (or second group of phonetic symbols) to represent Mandarin sounds. More specifically, the first group of phonetic symbols of Hanyu Pinyin includes “b”, “p”, “m”, “f”, “d”, “t”, “n”, “l”, “g”, “k”, “h”, “j”, “q”, “x”, “zh”, “ch”, “sh”, “r”, “z”, “c”, and “s” whereas examples of the second group of phonetic symbols of Hanyu Pinyin includes “a”, “o”, “e”, “ie”, “ai”, “ei”, “ao”, “ou”, “an”, “en”, “ang”, “eng”, “er”, “i”, “u”, and “ü”. Pronunciation of each Chinese character can be represented by a phonetic symbol combination including at least one of the phonetic symbols and one of five tones of the Hanyu Pinyin phonetic system.

The Hanyu Pinyin (or phonetic symbol combination, see reference number 23b) of the Chinese character 23A is preferably beside the Chinese character 23A. In the embodiment shown in FIG. 4, the Chinese character 23A includes two phonetic symbol components “b” (see the phonetic symbol designated by reference number 21A) and “o” (see the phonetic symbol designated by reference number 22A) which are respectively shown in a first phonetic symbol display section 21b above the Chinese character 23A and a second phonetic symbol display section 22b at a right side of the phonetic symbol combination 23b to show the constitution of the Hanyu Pinyin symbols of the Chinese character 23A.

Furthermore, other Chinese characters 24A, 25A, 26A, and 27A (see the Simplified Chinese characters [symbol] and [symbol] below the Chinese character 23A) are provided on the same page. These Chinese characters 24A-27A have the same Hanyu Pinyin symbol components as those of the Chinese character 23A but have different tones (see reference numbers 24b, 25b, 26b, and 27b).

A mark 211A is provided within or beside each of the phonetic symbol component 21A, the phonetic symbol component 22A, and the Chinese characters 23A-27A. The mark 211A contains pronunciation information in association with the corresponding one of the phonetic symbol component 21A, the phonetic symbol component 22A, and the Chinese words 23A-27A. As an example, a barcode 211A is contained in the phonetic symbol component 21A (see FIG. 5).

In a case that the reader 11 is a barcode reader, magnetic strip reader, or RFID reader, the mark 211A can be a barcode. In another case that the reader 11 is an optical character recognition reader, the mark 211A is exactly the corresponding one of the phonetic symbol component 21A, the phonetic symbol component 22A, and the Chinese characters 23A-27A. After reading the mark 211A with the optical character recognition reader, the shape of the mark 211A is identified by built-in software in the optical character recognition reader and converted into audio signal and then output via the microphone 114 or the speaker 13.

Furthermore, derivative Chinese words 28A derived from the Chinese characters 23A-27A and corresponding drawings 30A can be provided on the same page.

The phonetic teaching/correcting device according to the preferred teachings of the present invention allows repeated practice of correct pronunciation of phonetic symbols and Chinese characters in an economic and efficient way.

Although specific embodiments have been illustrated and described, numerous modifications and variations are still possible without departing from the teachings of the invention. The scope of the invention is limited by the accompanying claims.

What is claimed is:

1. A phonetic teaching/correcting device for learning Mandarin, with the Mandarin including a plurality of Chinese characters and a phonetic system that includes a plurality of phonetic symbols and a plurality of tone marks representing a plurality of tones, with pronunciation of each said Chinese character being represented by a phonetic symbol combination including one of the tone marks and at least one phonetic symbol component each of which is one of the plurality of phonetic symbols, with the phonetic teaching/correcting device comprising:
a book including a plurality of pages, with at least one of the plurality of pages including a first Chinese character, with said at least one of the plurality of pages further including at least one phonetic symbol component that constitutes a first phonetic symbol combination representing pronunciation of the first Chinese character, with said at least one of the plurality of pages further including a first mark in association with pronunciation of the first Chinese character and a second mark in association with pronunciation of each said at least one phonetic symbol component; and
a reading device including a reader for identifying the first and second marks, a processing unit, and a memory storing pronunciation information of a plurality of Chinese characters including the first Chinese character, with the reader being a barcode reader, a magnetic strip reader, a radio frequency identification reader, or an optical character recognition reader, with the processing unit receiving and processing identification result of the reader and outputting information of pronunciation of one of the first Chinese character and said at least one phonetic symbol component scanned by the reader, with the reading device further including a speaker having a wireless receiver, with the reader further including a wireless transmitter for transmitting signal indicative of the pronunciation of one of the first Chinese character and said at least one phonetic symbol component scanned by the reader to the wireless receiver, and with the speaker outputting the pronunciation of one of the first Chinese character and said at least one phonetic symbol component scanned by the reader.

2. The phonetic teaching/correcting device for learning Mandarin as claimed in claim 1, said at least one of the plurality of pages further including the first phonetic symbol combination representing pronunciation of and located beside the first Chinese character.

3. The phonetic teaching/correcting device for learning Mandarin as claimed in claim 1, with the first mark being a barcode within the first Chinese character, with the second mark being a barcode within each said phonetic symbol component of the first Chinese character, and with the reader being a barcode reader.

4. The phonetic teaching/correcting device for learning Mandarin as claimed in claim 1, with the first mark being a barcode beside the first Chinese character, with the second mark being a barcode beside each said phonetic symbol component of the first Chinese character, and with the reader being a barcode reader.

5. The phonetic teaching/correcting device for learning Mandarin as claimed in claim 1, with the first mark being a shape of the first Chinese character, with the second mark being a shape of each said phonetic symbol component of the first Chinese character, and with the reader being an optical character recognition reader.

6. The phonetic teaching/correcting device for learning Mandarin as claimed in claim 2, with said at least one of the plurality of pages further including a second Chinese character having a second phonetic symbol combination beside the second Chinese character and representing pronunciation of the second Chinese character, with the second phonetic symbol combination representing pronunciation of the second Chinese character including at least one phonetic symbol component identical to said at least one phonetic symbol component of the first Chinese character, and with the second phonetic symbol combination representing pronunciation of the second Chinese character further including a tone mark different from that of the first Chinese character.

7. The phonetic teaching/correcting device for learning Mandarin as claimed in claim 1, with said at least one of the plurality of pages further including a derivative Chinese word derived from the first Chinese character.

8. The phonetic teaching/correcting device for learning Mandarin as claimed in claim 7, with said at least one of the plurality of pages further including a drawing corresponding to the derivative Chinese word derived from the first Chinese character.

9. The phonetic teaching/correcting device for learning Mandarin as claimed in claim 6, with said at least one of the plurality of pages further including a derivative Chinese word derived from the second Chinese character.

10. The phonetic teaching/correcting device for learning Mandarin as claimed in claim 9, with said at least one of the plurality of pages further including a drawing corresponding to the derivative Chinese word derived from the second Chinese character.

11. The phonetic teaching/correcting device for learning Mandarin as claimed in claim 6, with said at least one of the plurality of pages further including a third mark in association with the pronunciation of the second Chinese character, and with the speaker outputting the pronunciation the second Chinese character when the third mark is scanned by the reader.

12. The phonetic teaching/correcting device for learning Mandarin as claimed in claim 1, with said at least one of the plurality of pages further including another four Chinese characters having four phonetic symbol combinations respectively representing pronunciation of said another four Chinese characters, with each of the four phonetic symbol combinations representing pronunciation of said another four Chinese characters including at least one phonetic symbol component identical to said at least one phonetic symbol component of the first Chinese character, and with the phonetic symbol combinations representing pronunciation of the first Chinese character and said another four Chinese characters having different tone marks.

13. The phonetic teaching/correcting device for learning Mandarin as claimed in claim 12, with said at least one of the plurality of pages further including a plurality of derivative Chinese words derived from the first Chinese character and said another four Chinese characters.

14. The phonetic teaching/correcting device for learning Mandarin as claimed in claim 13, with said at least one of the plurality of pages further including a plurality of drawings corresponding to the derivative Chinese words derived from the first Chinese character and said another four Chinese characters.

15. The phonetic teaching/correcting device for learning Mandarin as claimed in claim 1, with the phonetic system being Zhuyin fuhao system.

16. The phonetic teaching/correcting device for learning Mandarin as claimed in claim 1, with the phonetic system being Hanyu Pinyin system.
